(19) United States
(12) Patent Application Publication
(10) Pub. No.: US 2006/0202894 A1
(43) Pub. Date: Sep. 14, 2006

(54) Conductive Plastic Antenna

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 10/906,859

(22) Filed: Mar. 9, 2005

(51) Int. Cl. H01Q 1/38

(52) U.S. Cl. 343/700 MS

(57) ABSTRACT

The present invention is directed to an antenna device that includes at least one molded electrically conductive plastic component. The at least one molded electrically conductive plastic component has a material composition that includes a plastic base material and a concentration of electrically conductive particles. The antenna device is molded into a shape that is a function of antenna impedance. The antenna device has a size that is a function of a predetermined frequency range. The concentration of electrically conductive particles determines a conductivity of the antenna device.

### 1. FIELD OF THE INVENTION

The present invention relates generally to electronic components, and particularly to electrically conductive plastic components.

### 2. TECHNICAL BACKGROUND

Wireless communications is made possible by wireless electronic devices such as cellular telephones, pagers, smart cards, and two-way radios (e.g., FRS radios and GMRS radios), to name a few. Each of these devices must include an antenna to transmit and receive information-bearing electromagnetic signals. The physics of radio frequency (RF) design require that the antenna present a proper conductivity and impedance, as well as the proper wavelength and shape. Of course, these antenna characteristics are a function of the wireless electronic device itself. Accordingly, antennas come in many shapes, sizes, and forms depending on the application.

Most antennas consist of a combination of electrically conductive and insulating materials. Antennas may be fabricated using conductive materials such as wires, tubes, stamped metal, or similar components. Subsequently, the metallic component may be encapsulated inside a plastic cover. The plastic cover may be formed over the metal antenna by over-molding or simply inserting the metallic element into a plastic sheath. Of course, the antenna must be connected to the radio circuitry using some means. This connection is typically implemented by a built-in connector. An arrangement of wires may also be employed. Either way, the connective means is disposed between the antenna input and the RF circuitry. After the connecter is coupled to the input side of the antenna, it may be connected to the RF circuitry by solder or some another connective means.

In smart card applications, conductive tracks may be formed on flexible non-conductive strips using printing techniques. Subsequently, the end portions of the conductive traces must be individually connected to the device. Other methods for manufacturing antennas may include plating, conductive ink printing, and foil lamination techniques.

However, there are drawbacks to the aforementioned fabrication techniques. These fabrication methods may be labor intensive. Further, manufacturing costs are usually relatively high. What is needed is needed is a method for reducing the cost of making antennas by providing a molded conductive plastic antenna product.

### SUMMARY OF THE INVENTION

The present invention addresses the needs described above. One aspect of the present invention is directed to an antenna device that includes at least one molded electrically conductive plastic component. The at least one molded electrically conductive plastic component has a material composition that includes a plastic base material and a concentration of electrically conductive particles. The antenna device is molded into a shape that is a function of antenna impedance. The antenna device has a size that is a function of a predetermined frequency range.

In another aspect, the present invention includes electronic device that includes a housing, an RF circuit disposed in the housing, and an antenna device coupled to the RF circuit. The antenna device includes at least one molded electrically conductive plastic component. The at least one molded electrically conductive plastic component has a material composition that includes a plastic base material and a concentration of electrically conductive particles. The antenna device is molded into a shape that is a function of antenna impedance. The antenna device has a size that is a function of a predetermined frequency range.

In another aspect, the present invention is directed to a method for making an antenna. The method including the step of providing a mixture including a plastic base material and electrically conductive particles. A concentration of the electrically conductive particles is determined in accordance with a predetermined conductivity of the antenna. The plastic base material and the electrically conductive particles are mixed to provide an electrically conductive plastic mixture. The mixture has a material composition that includes a plastic base material and a concentration of electrically conductive particles. The mixture is injected into an antenna mold cavity, a shape of the antenna mold cavity being a function of antenna impedance and a size of the antenna mold cavity being a function of a predetermined frequency range. The mixture is cured in the antenna mold cavity to form a molded electrically conductive plastic component. The molded electrically conductive plastic component is ejected from the antenna mold cavity.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a perspective view of the conductive plastic antenna in accordance with one embodiment of the present invention; and

FIG. 2 is cross-sectional view of the conductive plastic antenna shown in FIG. 1.

### DETAILED DESCRIPTION

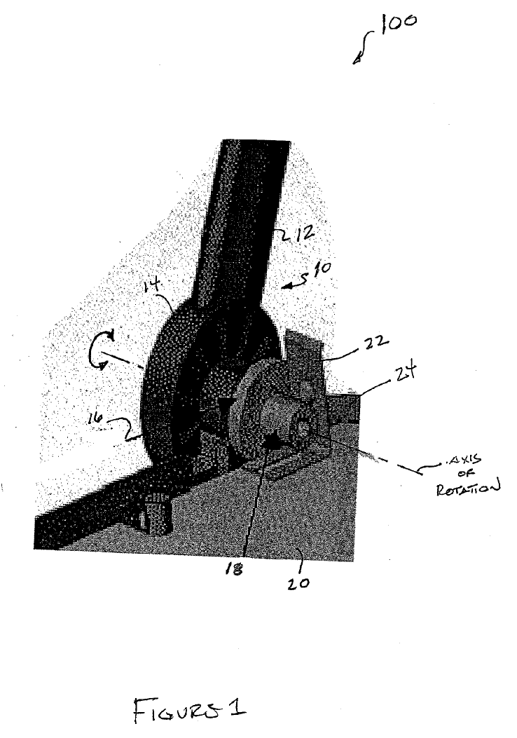

Reference will now be made in detail to the present exemplary embodiments of the invention, examples of which are illustrated in the accompanying drawings. Wherever possible, the same reference numbers will be used throughout the drawings to refer to the same or like parts. An embodiment of the conductive plastic antenna of the present invention is shown in FIG. 1, and is designated generally throughout by reference numeral 10.

As embodied herein, and depicted in FIG. 1, a perspective view of the conductive plastic antenna 10 in accordance with one embodiment of the present invention is disclosed. Antenna 10 is one component in electronic wireless device 100. Antenna device 10 includes antenna portion 12 coupled to a base member 14. Base member 14 includes a flange connector member 16 coupled thereto. A circuit connection member 18 protrudes from flange connector 16. Circuit connection member has a surface area that is configured to engage metal contact 22. Metal contact 22 is connected to an RF circuit (not shown) disposed with housing 24 of electronic device 100. At least a portion of the RF circuitry may be disposed on printed circuit board 20. Of course, electronic device 100 also includes a back cover (not shown) that mates with housing 24 and base member 14. The back cover prevents moisture, dust, and other contaminants from accessing the interior of device 100.

In the embodiment depicted in FIG. 1, flange member 16 allows antenna 10 to be captured between housing 24 and the back cover. Further, base member 14 and flange member 16 provide a rotational capability about an axis of rotation. Those skilled in the art will recognize that the physical orientation of the antenna determines the antenna polarization. If an RF signal is transmitted in one polarization state and is received by antenna 10 at a different polarization position, signal losses may occur. Accordingly, antenna 10 may be rotated to the appropriate polarization position.

Because antenna 10 is conductive, device 100 a connector is not required. A simple spring contact 22 is all that is needed to ensure electrical continuity between circuit connection member 18 and the RF circuitry. In one embodiment, spring member 22 may be mounted using a robotic placement mechanism to thereby reduce, or eliminate, any manual labor during the assembly process.

It will be apparent to those of ordinary skill in the pertinent art that modifications and variations can be made to the shape and size of the present invention depending on the type of antenna being manufactured, and the intended frequency band of operation. For example, an antenna manufactured for use in a cell phone may typically have an impedance of 50 Ohms. On the other hand, a half wave dipole antenna is nominally 75 ohms while a half wave folded dipole antenna is nominally 300 ohms. Of course, these examples should be construed as limiting the present invention, these examples are merely provided for illustrative purposes. Accordingly, the antenna impedance is a function of the shape of the antenna for a plastic material having a predetermined level of conductivity. The conductivity of the plastic material is controlled by the amount of conductive compound included in the plastic mixture. The antenna frequency response is likewise a function of antenna length. Thus, the size and length of the antenna are designed for optimum in-band performance.

In one embodiment of the present invention, antenna 10 may be electroplated with a conductive material such as chrome. For example, plating may be desired to achieve a desired skin effect. Those of ordinary skill in the art will recognize that skin effect is a tendency for a signal to propagate along the outer surface of a solid electrical conductor. The skin effect is proportional with frequency. In other words, the effect becomes more apparent as frequency increases. Further, skin effect increases the effective http://searchsmb.techtarget.com/sDefinition/0..sid44_gci212894.00.html resistance of a wire for signals propagating at moderate to high frequencies, compared with the resistance of the same conductor for signals propagating at direct current or relatively low frequencies. Thus, the skin effect is more pronounced in radio frequency (RF) systems, transmission lines, and antennas.

However, the conductive plastic antenna of the present invention may operate at any frequency. Antenna 10 may also be designed to operate in both wet and dry environments. In one embodiment, antenna 10 may be plated with a non-conductive material to make the surface impenetrable to the environment.

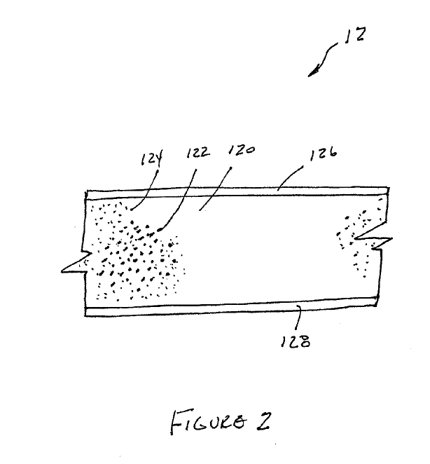

Referring to FIG. 2, a simplified and idealized cross-sectional view of a portion 12 of conductive plastic antenna 10 is shown. The plastic material used to mold antenna 10 includes a plastic base 120 and a conductive compound mixture, that includes carbon particles 122 and/or silver particles 124. In another embodiment, carbon fibers and/or metallic fibers may be employed. Additional compounds may be mixed in to add strength. As noted above and depicted in FIG. 2, in one embodiment of the present invention, a chrome plating 126 may be included to achieve a desired “skin effect”. Again, antenna 10 may be plated with a non-conductive material 128 to make the surface impenetrable to water, dust, and other environmental contaminants.

### EXAMPLES

The invention will be further clarified by the following examples which are intended to be exemplary of the invention. In one embodiment thereof, the present invention may provide a composition which is a mixture of a polymer and at least two different electrically conductive additives. The mixture in accordance with the present invention may typically include a polymer base material and at least one electrically conductive additive. The electrically conductive additive may include carbon and/or metallic particles. The metallic particles may be of any suitable type, such as silver particles. The electrically conductive additive may also include carbon fibers and/or metallic fibers. The metallic fibers may include stainless steel fibers.

The polymeric material employed herein may be suitable thermoplastic materials, such as polyamides, polyimides, polyesters, polyolefins, polysulfones, fluoropolymers, and mixtures thereof. In another embodiment, the thermoplastic may be a polyacetal resin polymer, also called polyoxymethylene. This material is often referred to by the abbreviated name “acetal” or “POM.” One suitable type of acetal resin polymer, which may be used in the practice of the present invention, is that sold commercially by DuPont under the trademark “DELRIN.” Another suitable thermoplastic is Nylon 12.

The antennas of the present invention may be fabricated using a method that includes the step of injecting a mixture into an antenna mold cavity. The mixture includes a plastic base material and a concentration of electrically conductive particles. In one embodiment, the polymer mixture includes a polymer material and an electrically conductive additive. The additive may be selected the group including metallic particles, carbon particles, carbon fibers, and/or metallic fibers. The mixture is cured in the antenna mold cavity to form a molded antenna component. The molded antenna component is subsequently ejected from the mold. The above-described method may also include initial steps of mixing the additives into a pulverized polymer, and melting the polymer (if a thermoplastic material is employed), to thereby provide a flowable mixture. The flowable mixture injected into the antenna mold. The flowable mixture may be injected into the antenna mold using conventional injection molding equipment. If carbon particles are employed in combination with steel fibers, the the carbon particles may exhibit a natural tendency to migrate towards the outer periphery of the mold, while the steel fibers remain at or near the core. After the injection step, the mold is cooled to allow the polymer to set and form a molded antenna component.

The molded antenna component is subsequently ejected from the mold.

The molded antenna component may be provided to an electronic wireless device for further assembly. Those skilled in the art will recognize that the present invention may be employed in wireless electronic devices such as cellular telephones, pagers, smart cards, FRS two-way radios, GMRS two-way radios, CB radios, and etc.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An antenna device comprising at least one molded electrically conductive plastic component, the at least one molded electrically conductive plastic component having a material composition that includes a plastic base material and a concentration of electrically conductive particles, the antenna device being molded into a shape that is a function of antenna impedance, and the antenna device having a size that is a function of a predetermined frequency range.

2. The device of claim 1, wherein the antenna device further comprises:
an antenna element configured to transmit and/or receive electromagnetic signals in the predetermined frequency range,
a connector element coupled to the antenna element, the connector element being configured to couple the antenna device to a housing; and
a circuit contact element coupled to the connector element and configured to provide a contact surface area, the contact surface area providing a signal interface for RF circuitry disposed in the housing.

3. The device of claim 2, wherein the antenna element, the connector element, and the circuit contact element are integrally formed, whereby the at least one molded electrically conductive plastic component is a single molded electrically conductive plastic component.

4. The device of claim 2, wherein the wherein at least one molded electrically conductive plastic component includes a plurality of molded electrically conductive plastic components.

5. The device of claim 2, wherein the connector element includes a flange, the flange being configured to be inserted into the housing.

6. The device of claim 5, wherein the flange is configured to rotate about a rotational axis to thereby move the antenna element into a position.

7. The device of claim 6, wherein the position is a function of signal polarization.

8. The device of claim 2, wherein the signal interface includes a metallic contact configured to accommodate the contact surface area, the metallic contact being electrically coupled to the RF circuitry.

9. The device of claim 8, wherein the metallic contact includes a spring element configured to exert a spring force against the circuit contact element.

10. The device of claim 1, wherein the plastic base material comprises a polymer material.

11. The device of claim 1, wherein the plastic base material is selected from a group consisting of nylon polymers, polyacetals, polyamides, polyimides, polyesters, polyolefins, polysulfones, fluoropolymers, and mixtures thereof.

12. The device of claim 1, wherein the electrically conductive particles includes metallic particles and/or metallic fibers.

13. The device of claim 1, wherein the electrically conductive particles includes electrically conductive carbon particles.

14. The device of claim 1, wherein the electrically conductive particles includes metallic particles, metallic fibers, and/or electrically conductive carbon particles.

15. The device of claim 1, further comprising plating disposed on a surface of the at least one molded electrically conductive plastic component.

16. The device of claim 15, wherein the plating is electrically conductive.

17. The device of claim 15, wherein the plating is not electrically conductive.

18. An electronic device comprising:
a housing;
an RF circuit disposed in the housing; and
an antenna device coupled to the RF circuit, the antenna device including at least one molded electrically conductive plastic component, the at least one molded electrically conductive plastic component having a material composition that includes a plastic base material and a concentration of electrically conductive particles, the antenna device being molded into a shape that is a function of antenna impedance, and the antenna device having a size that is a function of a predetermined frequency range.

19. A method for making an antenna, the method comprising:
providing a mixture including a plastic base material and electrically conductive particles;
determining a concentration of the electrically conductive particles in accordance with a predetermined conductivity of the antenna;
mixing the plastic base material and the electrically conductive particles to provide an electrically conductive plastic mixture, the mixture having a material composition that includes a plastic base material and a concentration of electrically conductive particles;
injecting the mixture into an antenna mold cavity, a shape of the antenna mold cavity being a function of antenna impedance and a size of the antenna mold cavity being a function of a predetermined frequency range;
curing the mixture in the antenna mold cavity to form a molded electrically conductive plastic component; and
ejecting the molded electrically conductive plastic component from the antenna mold cavity.

20. The method of claim 19, wherein the plastic base material comprises a polymer material.

21. The method of claim 19, wherein the plastic base material is selected from a group consisting of nylon polymers, polyacetals, polyamides, polyimides, polyesters, polyolefins, polysulfones, fluropolymers, and mixtures thereof.

22. The method of claim 19, wherein the electrically conductive particles include metallic particles and/or metallic fibers.

23. The method of claim 19, wherein the electrically conductive particles include electrically conductive carbon particles.

24. The method of claim 19, wherein the electrically conductive particles includes metallic particles, metallic fibers, and/or electrically conductive carbon particles.

25. The method of claim 19, further comprising the step of plating a surface of the at least one molded electrically conductive plastic component.

26. The method of claim 25, wherein the plating is electrically conductive.

27. The method of claim 25, wherein the plating is not electrically conductive.
